(19) United States
(12) Patent Application Publication
(10) Pub. No.: US 2019/0176197 A1
(43) Pub. Date: Jun. 13, 2019

(54) SOIL CONDITIONER AND PREPARATION METHOD THEREFOR

(71) Applicants: Guizhou Academy of Tobacco Science, Guiyang, Guizhou (CN); Nanjing Agricultural University, Nanjing, Jiangsu (CN)

(72) Inventors: Junxiong SHI, Guiyang, Guizhou (CN); Xingming YANG, Nanjing, Jiangsu (CN); Yanxia LIU, Guiyang, Guizhou (CN); Xiang LI, Guiyang, Guizhou (CN); Qirong SHEN, Nanjing, Jiangsu (CN); Biao SHEN, Nanjing, Jiangsu (CN); Zhiwen CHEN, Nanjing, Jiangsu (CN)

(73) Assignees: Guizhou Academy of Tobacco Science, Guiyang, Guizhou (CN); Nanjing Agricultural University, Nanjing, Jiangsu (CN)

(21) Appl. No.: 16/327,311

(22) PCT Filed: Dec. 19, 2017
(86) PCT No.: PCT/CN2017/117055

§ 371 Date: Feb. 21, 2019

(30) Foreign Application Priority Data
Aug. 7, 2017 (CN) 201710666420.7

(51) Int. Cl. B09C 1/10; C05F 3/00; C05F 17/00

(52) U.S. Cl. CPC B09C 1/105; B09C 2101/00; C05F 17/0009; C05F 3/00

(57) ABSTRACT

Disclosed is a soil conditioner, comprising the following components in parts by weight: 10-20 parts of distiller's grains; 1-10 parts of cow dung; 1-10 parts of vermicompost; 1-10 parts of oil cake; 10-20 parts of dregs of decoction; 20-40 parts of fallow soil; and 20-40 parts of river sand. Also disclosed is a method for preparing a soil conditioner, comprising: first, separately fermenting distiller's grains, cow dung, vermicompost, oil cake, and dregs of decoction, and then mixing them with river sand and fallow soil for secondary solid fermentation to obtain the soil conditioner. The present invention has a remarkable restoration effect on obstructive soil, the microbial diversity index of the restored soil is increased, the microbial ecological structure of the soil is improved, and the quality of crops is enhanced.

### FIELD

The present invention relates to a soil conditioner and a preparation method therefor, relating to the technical field of ecological restoration of soil.

### BACKGROUND

At present, in terms of restoration of obstructive soil, changing farming systems, improving fertilization methods and using soil improvement agents are main restoration methods. These restoration methods can only improve the obstructive soil finitely, and cannot restore the damaged microbial community in the obstructive soil. There are great limitations and the restoration effect is poor. There is also a method for restoring obstructive soil using bio-organic fertilizers. However, such bio-organic fertilizers are added with specific functional microorganisms, which are difficult to obtain and have limited functions.

### SUMMARY

The technical problem to be solved by the present invention is to overcome the defects of the prior art. The present invention provides a soil conditioner and a preparation method therefor. The present invention has a remarkable restoration effect on obstructive soil, the microbial diversity index of the restored soil is increased, the microbial ecological structure of the soil is improved, and the quality of crops is enhanced.

To solve the technical problem, the present invention provides a soil conditioner, including the following components in parts by weight:

10-20 parts of distiller's grains;

1-10 parts of cow dung;

1-10 parts of vermicompost;

1-10 parts of oil cake;

10-20 parts of dregs of decoction;

20-40 parts of fallow soil; and

20-40 parts of river sand.

Preferably, the soil conditioner includes the following components in parts by weight:

12 parts of distiller's grains;

8 parts of cow dung;

4 parts of vermicompost;

8 parts of oil cake;

12 parts of dregs of decoction;

30 parts of fallow soil; and

26 parts of river sand.

Preferably, the dregs of decoction comprise one or more of Radix Platycodi, Rhizoma Atractylodis Macrocephalae, Radix Pseudostellariae, Peristrophe baphica, Erigeron breviscapus, Dendrobium officinale Kimura et Migo, Rhizoma Bletillae, Herba Saxifragae, Radix Salviae Liguliobae, Ginkgo biloba, and Gynostemma pentaphyllum.

Preferably, the distiller's grains, cow dung, vermicompost, oil cake, and dregs of decoction are fermented distiller's grains, cow dung, vermicompost, oil cake, and dregs of decoction.

The present invention also provides a method for preparing a soil conditioner, including: first, separately fermenting distiller's grains, cow dung, vermicompost, oil cake, and dregs of decoction, and then mixing them with river sand and fallow soil for secondary solid fermentation to obtain the soil conditioner.

Preferably, the relative water content of the soil conditioner is 60%.

Preferably, the pH value of the soil conditioner is 7.0.

Preferably, the soil conditioner is subjected to secondary solid fermentation for 30-60 days under the environmental condition of 25-38° C.

The beneficial effects of the present invention are: the fallow soil in the soil conditioner provides microorganisms for restoring the obstructive soil; the distiller's grains, vermicompost, oil cake, dregs of decoction, and cow dung provide specific nutrient sources for domestication and culture of the microorganisms in the fallow soil; and the river sand is used to balance the formulation. By controlling the nutrient sources and culture conditions, the microorganisms in the fallow soil are domesticated and cultured. The obtained soil conditioner can ecologically restore the damaged microbial community system in the obstructive soil. The microorganisms in the soil conditioner cause the microbial flora structure in the obstructive soil to change towards the direction of facilitating production. The soil conditioner has a remarkable restoration effect on obstructive soil, the microbial diversity index of the restored soil is increased, the microbial ecological structure of the soil is improved, and the quality of crops is enhanced.

### DETAILED DESCRIPTION

The present invention is further described below. The following embodiments are merely used for more clearly describing the technical solutions of the present invention, but are not intended to limit the scope of protection of the present invention.

### Embodiment I

A soil conditioner includes the following components in parts by weight: 12 parts of distiller's grains; 8 parts of cow dung; 4 parts of vermicompost; 8 parts of oil cake; 12 parts of dregs of decoction; 30 parts of fallow soil; and 26 parts of river sand.

The dregs of decoction comprise one or more of Radix Platycodi, Rhizoma Atractylodis Macrocephalae, Radix Pseudostellariae, Peristrophe baphica, Erigeron breviscapus, Dendrobium officinale Kimura et Migo, Rhizoma Bletillae, Herba Saxifragae, Radix Salviae Liguliobae, Ginkgo biloba, and Gynostemma pentaphyllum.

The distiller's grains, cow dung, vermicompost, oil cake, and dregs of decoction are fermented distiller's grains, cow dung, vermicompost, oil cake, and dregs of decoction.

The present invention also provides a method for preparing the soil conditioner, including: first, separately fermenting distiller's grains, cow dung, vermicompost, oil cake, and dregs of decoction, and then mixing them with river sand and fallow soil for secondary solid fermentation; adjusting the relative water content to 60% and the pH value to 7.0; and performing continuous fermentation for 30 days under the environmental condition of 25° C. to obtain the soil conditioner.

### Embodiment II

A soil conditioner includes the following components in parts by weight:

12 parts of distiller's grains; 8 parts of cow dung; 5 parts of vermicompost; 10 parts of oil cake; 10 parts of dregs of decoction; 30 parts of fallow soil; and 25 parts of river sand.

The dregs of decoction comprise one or more of Radix Platycodi, Rhizoma Atractylodis Macrocephalae, Radix Pseudostellariae, Peristrophe baphica, Erigeron breviscapus, Dendrobium officinale Kimura et Migo, Rhizoma Bletillae, Herba Saxifragae, Radix Salviae Liguliobae, Ginkgo biloba, and Gynostemma pentaphyllum.

The distiller's grains, cow dung, vermicompost, oil cake, and dregs of decoction are fermented distiller's grains, cow dung, vermicompost, oil cake, and dregs of decoction.

The present invention also provides a method for preparing the soil conditioner, including: first, separately fermenting distiller's grains, cow dung, vermicompost, oil cake, and dregs of decoction, and then mixing them with river sand and fallow soil for secondary solid fermentation; adjusting the relative water content to 60% and the pH value to 7.0; and performing continuous fermentation for 60 days under the environmental condition of 38° C. to obtain the soil conditioner.

### Embodiment III

A soil conditioner includes the following components in parts by weight:

12 parts of distiller's grains; 8 parts of cow dung 3 parts of vermicompost; 5 parts of oil cake; 15 parts of dregs of decoction; 30 parts of fallow soil; and 27 parts of river sand.

The dregs of decoction comprise one or more of Radix Platycodi, Rhizoma Atractylodis Macrocephalae, Radix Pseudostellariae, Peristrophe baphica, Erigeron breviscapus, Dendrobium officinale Kimura et Migo, Rhizoma Bletillae, Herba Saxifragae, Radix Salviae Liguliobae, Ginkgo biloba, and Gynostemma pentaphyllum.

The distiller's grains, cow dung, vermicompost, oil cake, and dregs of decoction are fermented distiller's grains, cow dung, vermicompost, oil cake, and dregs of decoction.

The present invention also provides a method for preparing the soil conditioner, including: first, separately fermenting distiller's grains, cow dung, vermicompost, oil cake, and dregs of decoction, and then mixing them with river sand and fallow soil for secondary solid fermentation; adjusting the relative water content to 60% and the pH value to 7.0; and performing continuous fermentation culture for 49 days under the environmental condition of 31° C. to obtain the soil conditioner.

### Embodiment IV

The rating index of a soil conditioner is Shannon diversity index. The larger the Shannon diversity index of the obtained soil conditioner determined by a Biolog EcoPlate™ microplate method, the better the effect of the obtained product.

After the soil conditioner is obtained, its rating index is proven according to the quality of a crop after the soil conditioner is added to obstructive soil. Taking tobacco as an example, the Shannon diversity index of rhizosphere soil during the maturity stage of the tobacco, agronomic characteristic (plant height, stem circumference, maximum leaf length, maximum leaf width, and effective leaf number) 5d after topping, and dry weight (root dry weight, stem dry weight, and leaf dry weight) are regarded as indicators. By measuring the values of these indicators and comparing these values with the relevant indicators of the tobacco plants planted in the obstructive soil, conventionally planted tobacco plants, and conventionally planted tobacco plants to which an undomesticated and uncultured formulation is added, to prove the rating index.

The prepared soil conditioner is applied to tobacco soil restoration. An experiment is designed to evaluate the restoration effect of the soil conditioner. The experimental scheme comprises treating soil by applying nitrogen only in Longgang long-term positioned point+soil conditioner treatment and five rating comparisons. The scheme is as shown in the following table:

| Treatment | Referred to as |
|---|---|
| Treating soil by applying nitrogen only in Longgang | N |
| long-term positioned point | |
| Treating soil by applying nitrogen, phosphorus, and | NPK |
| potassium in Longgang long-term positioned point | |
| Treating soil by applying nitrogen only in Longgang | N + the same |
| long-term positioned point + the same nutritional | nutritional |
| components as those of soil conditioner | components |
| Treating soil by applying nitrogen only in Longgang | N + |
| long-term positioned point + undomesticated and | undomesticated |
| uncultured soil conditioner | conditioner |
| Treating soil by applying nitrogen only in Longgang | N + conditioner |
| long-term positioned point + soil conditioner | |
| Treating soil by applying nitrogen, phosphorus, and | NPK + |
| potassium in Longgang long-term positioned point + | undomesticated |
| undomesticated and uncultured soil conditioner | conditioner |

Experiment is carried out according to the scheme. During the experiment, the Shannon diversity index and the agronomic characters (plant height, stem circumference, maximum leaf length, maximum leaf width, and effective leaf number) 5d after the topping are measured. The results are as follows:

| | Shannon | | | |
|---|---|---|---|---|
| | diversity | Root dry | Stem dry | Leaf dry |
| Treatment | index | weight | weight | weight |
| N | 2.49 ± 0.16 | 1.61 ± 1.24 | 7.09 ± .56 | 11.95 ± 3.19 |
| NPK | 3.02 ± 0.09 | 4.01 ± 1.46 | 8.94 ± .83 | 16.14 ± 5.00 |
| N + the same | 2.83 ± 0.36 | 2.91 ± 1.28 | 9.64 ± .93 | 18.27 ± 4.45 |
| nutritional | | | | |
| components | | | | |
| N + | 2.87 ± 0.05 | 1.80 ± 1.25 | 6.33 ± .88 | 17.28 ± 1.79 |
| undomesticated | | | | |
| conditioner | | | | |
| N + | 3.35 ± 0.15 | 4.43 ± 1.25 | 11.84 ± .37 | 22.85 ± 5.38 |
| conditioner | | | | |
| NPK + | 3.14 ± 0.05 | 3.87 ± 0.85 | 9.69 ± .77 | 22.42 ± 3.75 |
| undomesticated | | | | |
| conditioner | | | | |

| | | Stem | Maximum | Maximum | effective |
|---|---|---|---|---|---|
| | Plant height | circumference | leaf length | leaf width | leaf number |
| Treatment | (cm) | (cm) | (cm) | (cm) | (leaves) |
| N | 68.16 ± 11.04 | 5.06 ± 0.36 | 52.74 ± 2.52 | 25.20 ± 2.63 | 16.20 ± 1.92 |
| NPK | 92.24 ± 7.70 | 5.50 ± 0.23 | 54.52 ± 1.94 | 24.92 ± 1.50 | 20.40 ± 0.55 |
| N + the same | 89.06 ± 9.48 | 5.84 ± 0.27 | 55.02 ± 2.61 | 26.48 ± 1.86 | 20.60 ± 2.07 |
| nutritional | | | | | |
| components | | | | | |
| N + | 71.30 ± 13.19 | 4.68 ± 0.24 | 48.60 ± 3.35 | 22.66 ± 1.30 | 18.00 ± 1.00 |
| undomesticated | | | | | |
| conditioner | | | | | |
| N + | 102.34 ± 10.74 | 5.84 ± 0.65 | 56.48 ± 2.47 | 27.80 ± 2.64 | 22.40 ± 1.34 |
| conditioner | | | | | |
| NPK + | 98.00 ± 18.66 | 5.72 ± 0.24 | 59.76 ± 3.65 | 27.48 ± 1.77 | 21.20 ± 0.84 |
| undomesticated | | | | | |
| conditioner | | | | | |

The restoration effect of the soil conditioner can be evaluated by measuring the Shannon diversity index, agronomic characters, and dry weight of different treatments. By comparing N+soil conditioner treatment with N, NPK, N+the same nutritional components, N+undomesticated conditioner, NPK+undomesticated conditioner treatment, it can be found that the soil conditioner of the present invention has a very good restoration effect on tobacco-planting obstructive soil. Its indicators are higher than those of the NPK treatment of normal planting, even better than those of the NPK+undomesticated conditioner treatment having an ideal effect. Hence, the soil conditioner has a good restoration effect on the obstructive soil.

The above are only preferred embodiments of the present invention. It should be noted that many modifications and variations can be made thereto for a person skilled in the art without departing from the technical principle of the present invention, and those modifications and variations should also be regarded as falling within the scope of protection of the present invention.

1. A soil conditioner, comprising the following components in parts by weight:
10-20 parts of distiller's grains;
1-10 parts of cow dung;
1-10 parts of vermicompost;
1-10 parts of oil cake;
10-20 parts of dregs of decoction;
20-40 parts of fallow soil; and
20-40 parts of river sand.

2. The soil conditioner according to claim 1, comprising the following components in parts by weight:
12 parts of distiller's grains;
8 parts of cow dung;
4 parts of vermicompost;
8 parts of oil cake;
12 parts of dregs of decoction;
30 parts of fallow soil; and
26 parts of river sand.

3. The soil conditioner according to claim 1, wherein,
the dregs of decoction comprise one or more of Radix Platycodi, Rhizoma Atractylodis Macrocephalae, Radix Pseudostellariae, Peristrophe baphica, Erigeron breviscapus, Dendrobium officinale Kimura et Migo, Rhizoma Bletillae, Herba Saxifragae, Radix Salviae Liguliobae, Ginkgo biloba, and Gynostemma pentaphyllum.

4. The soil conditioner according to claim 1, wherein,
the distiller's grains, cow dung, vermicompost, oil cake, and dregs of decoction are fermented distiller's grains, cow dung, vermicompost, oil cake, and dregs of decoction.

5. A method for preparing a soil conditioner, comprising the following steps
first, separately fermenting distiller's grains, cow dung, vermicompost, oil cake, and dregs of decoction, and then mixing them with river sand and fallow soil for secondary solid fermentation to obtain the soil conditioner.

6. The method for preparing a soil conditioner according to claim 5, wherein,
the relative water content of the soil conditioner is 60%.

7. The method for preparing a soil conditioner according to claim 5, wherein,
the pH value of the soil conditioner is 7.0.

8. The method for preparing a soil conditioner according to claim 5, wherein,
the soil conditioner is subjected to secondary solid fermentation for 30-60 days under the environmental condition of 25-38° C.

9. The soil conditioner according to claim 2, wherein,
the dregs of decoction comprise one or more of Radix Platycodi, Rhizoma Atracylodis Macrocephalae, Radix Pseudostellariae, Peristrophe baphica, Erigeron breviscapus, Dendrobium officinale Kimura et Migo, Rhizoma Bletillae, Herba Saxifragae, Radix Salviae Liguliobae, Ginkgo biloba, and Gynostemma pentaphyllum.

10. The soil conditioner according to claim 2, wherein,
the distiller's grains, cow dung, vermicompost, oil cake, and dregs of decoction are fermented distiller's grains, cow dung, vermicompost, oil cake, and dregs of decoction.
